(19) United States
(12) Patent Application Publication
(10) Pub. No.: US 2013/0124630 A1
(43) Pub. Date: May 16, 2013

(54) DEVICE AND/OR USER IDENTIFICATION

(71) Applicants: Jukka Pekka Reunamaki, Tampere (FI); Arto Tapio Palin, Viiala (FI)

(72) Inventors: Jukka Pekka Reunamaki, Tampere (FI); Arto Tapio Palin, Viiala (FI)

(73) Assignee: NOKIA CORPORATION, Espoo (FI)

(21) Appl. No.: 13/639,989

(22) PCT Filed: Apr. 8, 2010
(86) PCT No.: PCT/FI10/50277

§ 371 Date: Jan. 29, 2013

(51) Int. Cl. H04W 8/00

(52) U.S. Cl. CPC H04W 8/005
USPC 709/204

(57) ABSTRACT

In accordance with an example embodiment of the present invention, an apparatus, a computer program product and a method is provided for device and/or user identification. The example embodiment comprises receiving, at an apparatus, a wireless signal comprising at least one of an address or an indication identifying a wireless 5 communication device initiating the wireless signal, transmitting a query to a remote network entity, the query including at least one of the received address or indication identifying the wireless communication device and an indication associated with identity of the apparatus, and receiving a response to the query including information relating to identity of the wireless communication device if an association exists between the 10 apparatus and the wireless communication device.

### TECHNICAL FIELD

The present application relates generally to wireless communication and device and/or user identification.

### BACKGROUND

Modern society has adopted, and is becoming reliant upon, wireless communication devices for various purposes, such as, connecting users of the wireless communication devices with other users. Wireless communication devices can vary from battery powered handheld devices to stationary household and/or commercial devices utilizing an electrical network as a power source. Due to rapid development of the wireless communication devices a number of areas capable of enabling entirely new types of communication applications have emerged.

A user of a wireless communication device intentionally activating a wireless connection for example to gain access to a network or to establish a communication connection with another device, etc. needs to first present device and/or user identification information in order to commence communication. While this information is primarily intended for a target receiving device, there is no certainty that the target device is the only device listening to the wireless transaction. In fact, every other device within transmission range of the wireless communication device may also receive this information.

### SUMMARY

Various aspects of examples of the invention are set out in the claims.

According to a first aspect of the present invention, a method is provided comprising receiving, at an apparatus, a wireless signal comprising an indication identifying a wireless communication device initiating the wireless signal. The method further comprising transmitting a query to a remote network entity, the query including the received indication identifying the wireless communication device and an indication associated with identity of the apparatus, and receiving a response to the query including information relating to identity of the wireless communication device if an association exists between the apparatus and the wireless communication device.

According to a second aspect of the present invention, a computer program product is disclosed, adapted to cause performation of the method according to the first aspect when said program is run on a computer.

According to a third aspect of the present invention, an apparatus is disclosed, comprising means for means receiving, at an apparatus, a wireless signal comprising an indication identifying a wireless communication device initiating the wireless signal. The apparatus further comprising means for transmitting a query to a remote network entity, the query including the received indication identifying the wireless communication device and an indication associated with identity of the apparatus, and means for receiving a response to the query including information relating to identity of the wireless communication device if an association exists between the apparatus and the wireless communication device.

According to a fourth aspect of the present invention, a method is provided comprising receiving a query from an apparatus, the query including an indication associated with identity of the apparatus and an indication identifying another device. The method further comprising resolving identity associated with the indication identifying the another device included in the query and determining whether an association exists between the resolved identity and the identity of the apparatus initiating the query, and transmitting a response to the query including information relating to resolved identity if the association exists between the resolved identity and the identity of the apparatus initiating the query.

According to a fifth aspect of the present invention, a computer program product is disclosed, adapted to cause performation of the method according to the fourth aspect when said program is run on a computer.

According to a sixth aspect of the present invention, an apparatus is disclosed, comprising means for receiving a query from an apparatus, the query including an indication associated with identity of the apparatus and an indication identifying another device. The apparatus further comprising means for resolving identity associated with the indication identifying the another device included in the query and determining whether an association exists between the resolved identity and the identity of the apparatus initiating the query, and means for transmitting a response to the query including information relating to resolved identity if the association exists between the resolved identity and the identity of the apparatus initiating the query.

According to a seventh aspect of the present invention, an apparatus is disclosed, comprising at least one processor and at least one memory including executable instructions, the at least one memory and the executable instructions being configured to, in cooperation with the at least one processor, cause the apparatus to perform at least the following: Receive a wireless signal comprising at an indication identifying a wireless communication device initiating the wireless signal; transmit a query to a remote network entity, the query including the received indication identifying the wireless communication device and an indication associated with identity of the apparatus; and receive a response to the query including information relating to identity of the wireless communication device if an association exists between the apparatus and the wireless communication device.

According to an eight aspect of the present invention, an apparatus is disclosed, comprising at least one processor and at least one memory including executable instructions, the at least one memory and the executable instructions being configured to, in cooperation with the at least one processor, cause the apparatus to perform at least the following: Receive a query from an apparatus, the query including an indication associated with identity of the apparatus and an indication identifying another device; resolve identity associated with the indication identifying the another device included in the query and determine whether an association exists between the resolved identity and the identity of the apparatus initiating the query; and transmit a response to the query including information relating to resolved identity if the association exists between the resolved identity and the identity of the apparatus initiating the query.

### BRIEF DESCRIPTION OF THE DRAWINGS

For a more complete understanding of example embodiments of the present invention, reference is now made to the following descriptions taken in connection with the accompanying drawings in which:

FIG. 1 discloses an example of operational environment in which apparatuses according to an example embodiment of the invention may be used;

FIG. 2 discloses a modular layout for an example apparatus according to an example embodiment of the present invention;

FIG. 3 illustrates example contents of a database according to one embodiment of the present invention;

FIG. 4 illustrates a flow diagram showing operations for acquiring identity of a wireless communication device according to an example embodiment of the present invention;

FIG. 5 illustrates a flow diagram showing operations for resolving identity of an apparatus according to an example embodiment of the present invention; and

FIG. 6 discloses an apparatus comprising example hardware for implementing computer software instructions stored in the apparatus according to an example embodiment of the present invention.

### DETAILED DESCRIPTION OF THE DRAWINGS

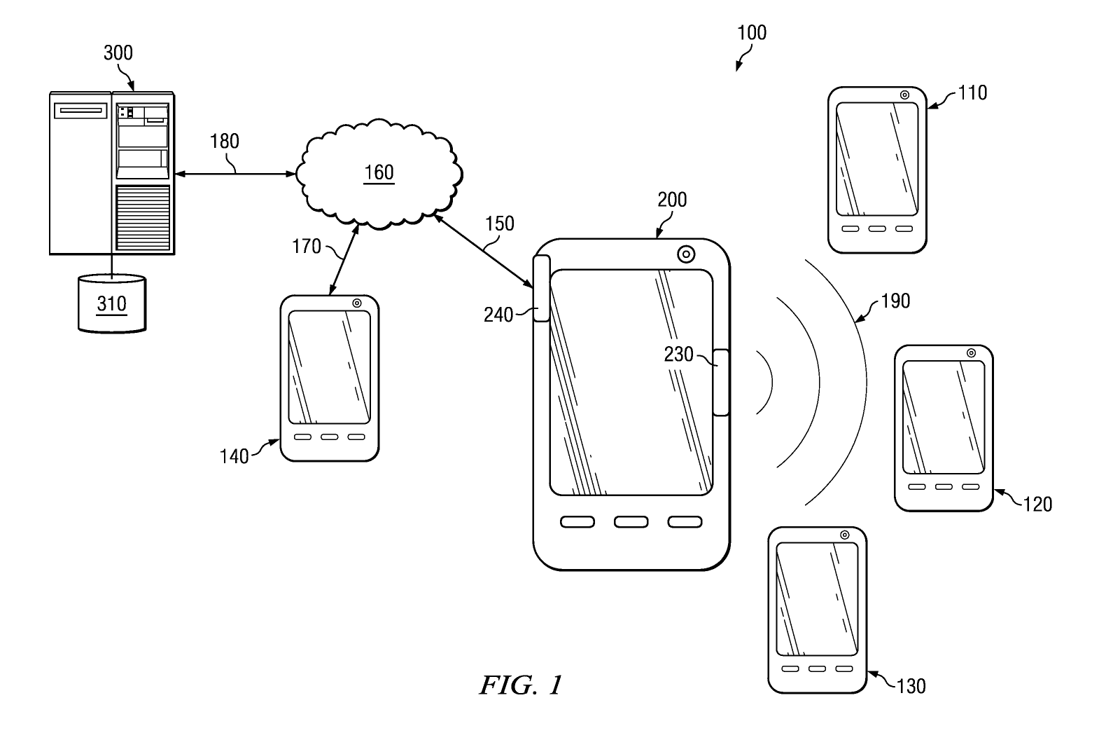

An example embodiment of the present invention and its potential effects are understood by referring to FIGS. 1 through 6 of the drawings.

FIG. 1 discloses an example of operational environment 100 in which various apparatuses according to an example embodiment of the invention may be used. An apparatus 200, for example a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, or the like is shown having communication means, such as a short-range communications interface 230, configured to communicate wirelessly with various short-range communication devices, such as a devices 110, 120 and 130 via a short-range communication connection. Short-range communication connections may be used for the exchange of information over a local area varying for example from a couple of meters to some hundred of meters. Examples of wireless short-range communication technologies comprise Bluetooth™, Bluetooth™ Low Energy, WLAN, wireless universal serial bus (WUSB), ultra-wideband (UWB), ZigBee (802.15.4, 802.15.4a), and ultra high frequency radio-frequency identification (UHF RFID) technologies. The apparatus 200 may further be embodied as a portable wireless communications device equipped with wide-area communication means, such as long-range communications interface 240 to connect with network 160 via a wireless communication link 150 to communicate for example either with a wireless communication device 140, or with a remote server 300 as illustrated in FIG. 1.

Depending on the embodiment, the wireless communication link 150 may be provided over a wide-are communication connection. Examples of wireless wide-area communication technologies comprise 2^{nd} generation (2G) digital cellular networks, for example Global System for Mobile Communications (GSM) that may communicate in the 900 MHz/1.8 GHz bands in Europe and in the 850 MHz and 1.9 GHz bands in the United States. Wide-area communication technologies may further comprise general packet radio service (GPRS) technology, universal mobile telecommunications system (UMTS) technology, code division multiple access (CDMA) technologies, and/or the like.

According to an alternative example embodiment, the link 150 may be provided with a wired connection. Examples of wired communication technologies include ethernet, IEEE 1394, universal serial bus (USB) protocol, any other serial or parallel wired connection, and/or the like. Network 160 may be either a wireless network, or a wired network. Network 160 may further be connected to other networks. According to a further example embodiment, apparatus 200 may be a stationary device having a wireless and/or a wired interface for communicating with network 160.

As further shown in FIG. 1 various other devices, such as other mobile device 140 and server 300 including a database 310 may be connected to the network 160 via respective links (170 and 180) so that apparatus 200 may communicate with any of the other devices via the network 160.

According to one example embodiment of the present invention, the apparatus 200, such as a wireless communication device, upon initiating a wireless short-range communication with another one or more wireless communication devices, such as any of the devices 110, 120 or 130 through a wireless short-range communication link 190, needs to first present device and/or user identification information in order to commence communication. While this information is primarily intended for a target receiving device, such as device 120 according to one embodiment of the present invention, there is no certainty that the target receiving device is the only device listening to the wireless transaction. In fact, every other device within transmission range of the apparatus 200, such as devices 110 and 130 of example embodiment of FIG. 1 may also receive this information. Under normal circumstances, the other uninvolved wireless devices would ignore this information. However, these transmissions may also be recorded by a listening device to gain identification information about the user and/or user's wireless communication device, which may be employed to later locate the user and/or user's wireless communication device, which may create a privacy risk every time when device and/or user identification information is made available.

Further, while a user of a wireless communication device may enable the wireless communication device, such as apparatus 200, to automatically download useful information via a wireless communication connection, the fact that previously unknown devices may connect at will to the apparatus 200 presents another security issue. A person with mischievous or malicious intent could use any information obtained from the user's wireless communication device 200 to learn sensitive or confidential information about the user, obtain sensitive or confidential information related to a user's employment and possibly even track the current location of the user. As a result, persons utilizing wireless communication devices, such as apparatus 200, must continually weigh whether they want to expose themselves to a potential threat against using the beneficial communication features included in their wireless communication device.

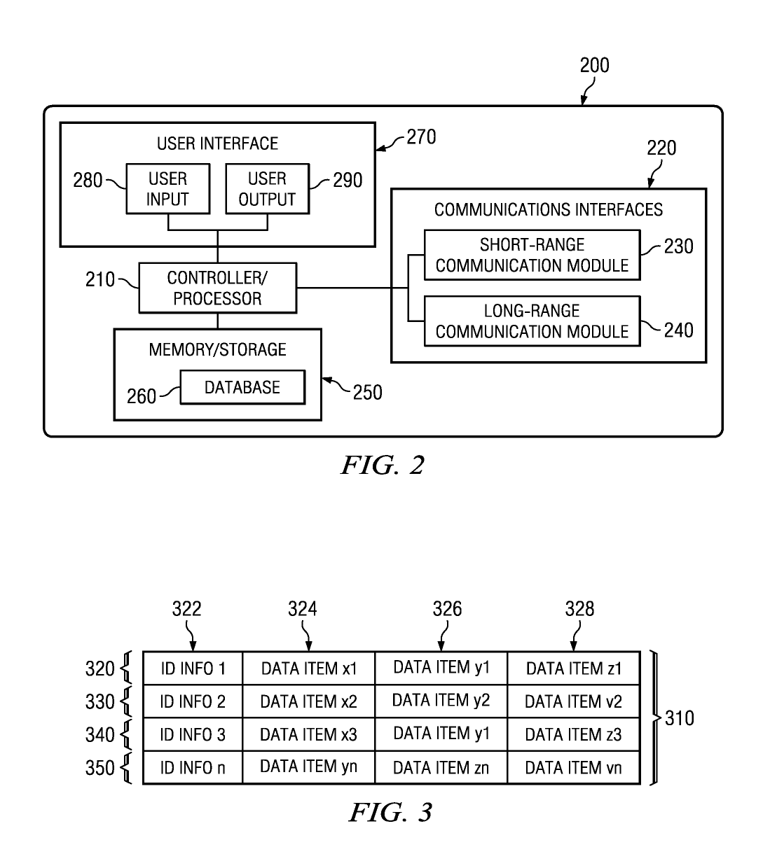

FIG. 2 discloses a modular layout for an example apparatus according to an example embodiment of the present invention. In FIG. 2, apparatus 200 is broken down into modules configured to cause the apparatus to perform various functionalities. The functionalities may be provided by various combinations of the software and/or hardware components discussed below according to an embodiment of the present invention.

Control module 210 is configured to regulate operation of the apparatus 200. The control module may be embodied as a controlling means, for example as a controlling circuitry or a processor. Inputs for the control module 210 may be received from various other modules comprised within apparatus 200. For example, user interface 270 may provide input to the control module 210 in response to receiving input from a user via user input 280. So, user input received via the user interface 270 may be used as an input in the control module 210 for controlling the operation of the apparatus 200. Control module 210 may interpret and/or process the input data and, in response, may issue one or more control commands to at least one of the other modules within apparatus 200.

In accordance with an example embodiment, apparatus 200, embodied for example as a wireless communication device, comprises communications interfaces 220. Communications interfaces 220 may incorporate one or more communication modules of the apparatus 200. In an example embodiment, the communications interfaces 220 may comprise means for wired and/or wireless communication. As shown in the example of FIG. 2, communications interfaces 220 may comprise a short-range communications module 230 and a long-range communications module 240. It should be understood that although FIG. 2 illustrates only one short-range communication module 230 and one long-range communication module 240 for the sake of clarity, apparatus 200 may comprise any number of further communications modules. For example, two or more additional wired and/or wireless communication modules may be included in the apparatus 200. Apparatus 200 may utilize one or more of these modules to receive information from both local and long distance sources, and to transmit data to recipient devices from apparatus 200. Communications interfaces 220 may be activated by control module 210, or by control resources local to the sub-modules responding to received messages, environmental influences and/or other devices in communication with the apparatus 200.

Short-range wireless networks provide communication solutions that avoid some of the problems seen in large cellular networks. Bluetooth™ is an example of a short-range wireless technology quickly gaining acceptance in the marketplace. Bluetooth™ enabled wireless communication device may transmit and receive data rates from 720 Kbps up to 2-3 Mbps within a range of 10 meters, and may transmit up to 100 meters with additional power boosting. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members. In addition to Bluetooth™ and Bluetooth™ Low Energy, other popular short-range wireless networks include WLAN (of which “Wi-Fi” local access points communicating in accordance with the IEEE 802.11 standard, is an example), WUSB, UWB, ZigBee (802.15.4, 802.15.4a), and UHF RFID. All of these wireless mediums have features and advantages that make them appropriate for various applications.

Short-range communication module 230 may comprise short-range communication interface embodied for example as a transmitter and/or receiver for exchanging information across short-range wireless network using a short-range communication protocol. Example communication protocols for short-range communication may comprise Bluetooth™, Bluetooth™ Low Energy, wireless local area network (WLAN), ultra-wide band (UWB), and wireless universal serial bus (WUSB) technologies. Bluetooth™ Low Energy communication protocol provides a security enhancing feature for creating temporary identification information that may be used to mask actual identification of the wireless communication device. The temporary identification information may be used by other devices in communicating with the apparatus 200. However, only other devices possessing secret address component information may determine the actual identity of the masked wireless communication device. The temporary identification information may further be recompiled when a threshold condition is satisfied.

Long-range communication module 240 may comprise a long-range communications interface configured to communicate and exchange information over a long distance in a large geographic area using any of the wide-area communication technologies described earlier. Examples of wireless long-range communication technologies comprise 2^{nd} generation (2G) digital cellular networks, for example Global System for Mobile Communications (GSM) that may communicate in the 900 MHz/1.8 GHz bands in Europe and in the 850 MHz and 1.9 GHz bands in the United States. Long-range communication technologies may further comprise general packet radio service (GPRS) technology, universal mobile telecommunications system (UMTS) technology, code division multiple access (CDMA) technologies, and/or the like. Long-range communication technologies may also operate to transmit and receive messages, such as text messages via a short messaging service (SMS), and/or multimedia content via multimedia messaging service (MMS) messages. Long-range communication technologies may provide voice and data services.

As a subset of long-range communications module 240, or alternatively operating as an independent module separately coupled to processor 210, the apparatus 200 may comprise a broadcast receiver. The broadcast receiver may be a digital audio- or video receiver, for example a digital audio broadcasting (DAB) or a digital video broadcasting (DVB) receiver, and/or the like. According to an example embodiment, the broadcast receiver comprises a Digital Video Broadcast for Handheld Apparatuses (DVB-H) receiver. The broadcasting transmissions may be encoded so that only certain apparatuses may access the transmitted content. The broadcast transmission may comprise text, audio and/or video information, and data. In an example embodiment, apparatus 200 may receive broadcasts and/or information within the broadcast signal to determine if the apparatus is permitted to view the received content.

According to one example embodiment either the short-range communications module 230, or the long-range communications module 240 may be equipped with a wired interface that may be used for communicating with another device using a wired communication protocol via an interface such as Ethernet, an IEEE 1394 communication interface, a universal serial bus (USB) interface, and/or the like.

User interface 270 may include visual, audible and/or tactile elements which allow a user to receive data from, and enter data into, the apparatus. Data entered by a user is received via user input module 280 and may be interpreted by control module 210, for example to affect the behavior of apparatus 200. User-inputted data may also be transmitted via any of the communication modules of the communications interfaces 220 to another device. Information may also be received by other devices at the apparatus 200 via communications interfaces 220. Control module 210 may cause this information to be transferred to user interface 270 for presentation to the user via user output module 290. User interface 270 may comprise one or more user input and output modules, and there may also be a module operating both as a user input module 280 and user output module 290, for example a touch screen display operating as a tactile user interface.

Apparatus 200 may further comprise a memory and/or storage 250. Memory/storage 250 may be connected to controller 210. Memory/storage 250 may include a database 260. The database 260 may comprise one or more data items, such as information related to original identification of the apparatus, and related data items for creating private address for masking the original identity of the apparatus 200. Memory/storage 250 may further store executable instructions that are configured to cause the apparatus 200 to perform various actions in co-operation with the control module 210.

According to one embodiment of the present invention, any of the wireless communication devices of example FIG. 1, including apparatus 200 and wireless communication devices 110-140 may implement a security enhancing feature for creating temporary identification information that is used to mask actual identification of the wireless communication device in question. When a wireless communication uses such a temporary indentification, only other devices possessing secret address component information may determine the actual identity of the masked wireless communication device. The temporary identification information may further be recompiled when a threshold condition is satisfied.

Example communication technology implementing the security enhancing feature where a wireless communication device may mask its true identity through a temporary pseudo-random address is Bluetooth™ Low Energy. In the case of communication over a Bluetooth™ Low Energy, at least two types of addresses may be defined: public and private. Public addresses are normal, fixed addresses, and may be used for example in devices like access points, fixed sensors, etc. where there is little or no concern regarding privacy, or other security threats. Public addresses may be generated similarly as private addresses, but they are never changed. Instead, public addresses remain fixed over time so that clients may memorize and reconnect to these devices at a later time.

A wireless communication device, such as apparatus 200 of FIG. 1, may alter its private address periodically, but not usually during a connection. According to one example embodiment, a wireless communication device, such as apparatus 200 of FIG. 1, may perform private address generation selecting a random address component that is concatenated with a secret address to yield a private address. This private address may be used when communicating with other devices while masking the actual identity of the apparatus.

According to one embodiment of the present invention, necessary information for deciphering a private address of an apparatus, such as a private address of any of the apparatuses 110, 120, or 130 of FIG. 1 may be maintained on a remote server, such as in a database 310 of server 300 of FIG. 1. FIG. 3 illustrates example contents of such a database according to one embodiment of the present invention. Example database 310 comprises one or more user accounts, such as accounts 320, 330, 340 and 350 shown on FIG. 3. As further shown on FIG. 3, each of the user accounts comprise a plurality of data items, such as data items 322, 324, 326 and 328 within user account 320. According to one example of the present invention, data item 322 comprises ID information that identifies a specific user account from other user accounts. So, whenever an apparatus, such as apparatus 200 of FIG. 1 transmits a query to server 300, server 300 checks whether a corresponding user account can be found based on the available ID information. Example ID information comprise user name, device identification information and contact information for the user. Data items 324, 326 and 328 may comprise information relating to the devices and/or users having secure association with the user associated with the respective user account. As an example, data item 324 may include the necessary information for deciphering the private address of apparatus 110 of FIG. 1, data item 326 may include necessary information for deciphering the private address of apparatus 120 of FIG. 1 and data item 328 may include the necessary information for deciphering the private address of apparatus 130 of FIG. 1.

According to one embodiment of the present invention, whenever an apparatus, such as wireless communication device 200 of FIG. 1 receives a wireless signal including an address or any kind of indication identifying initiating apparatus for example from apparatus 120 that it cannot resolve locally, it may transmit a query including the received address or the indication and some sort of indication of its own identity, such as device identification or like, to a remote server 300. Server 300, upon receiving the query, may perform a check, based on the information contained on database 310 whether an association exists between the address and/or indication included in the query and the identity information provided by the apparatus. Server 300 may select a user account associated with the received identity information by finding a matching ID information data item from the data base. According to one example, ID info data item 322 of user account 320 shown on FIG. 3 matches with the identity information included in the query sent by apparatus 200. After selection of the user account, server 300 can try to decipher the received address and/or indication using any of the plurality of data items 324, 326, 328 contained in the user account 320 of FIG. 3.

If an association between the received address and/or indication and the identity is found, i.e. server can resolve identity of the apparatus and/or user associated with the received address and/or indication using the information included in any of the data items 324, 326, 328 included in the user account 320, server responds to the query with a message including information relating to the resolved identity. If server 300 cannot resolve the identity of the apparatus and/or user associated with the received address and/or indication using the information included in any of the data items 324, 326, 328 included in the user account 320, the server responds to the query with a message indicating unsuccessful identity resolving.

Upon receiving the response including information relating to the resolved identity from server 300, apparatus 200 may establish a communication connection with the apparatus 120 using the information included in the received response.

According to an embodiment of the invention, information included in one or more user accounts may be updated. For example, whenever another device is acquired by a user, necessary information for updating data items associated with the user, such as any of the data items 324, 326, 328 of FIG. 3 may be updated accordingly. Updating of the one or more data items associated with the user may happen by connecting to server, such as server 300 illustrated on example FIG. 1 with a wireless communication device, such as any of the apparatuses 110, 120, 130, 140 or 200 of the FIG. 1. Alternatively, necessary information for updating the one or more data items associated with the user may be provided through other means, such as via an available computer that is connected to the Internet. Further, as information associated with users is maintained at the server, users can easily update their private information so that devices requesting information about the identity of the user and/or apparatus of the user are provided with up to date information without requiring to form secure association between the devices every time the counterpart device is changed for some reason or the other.

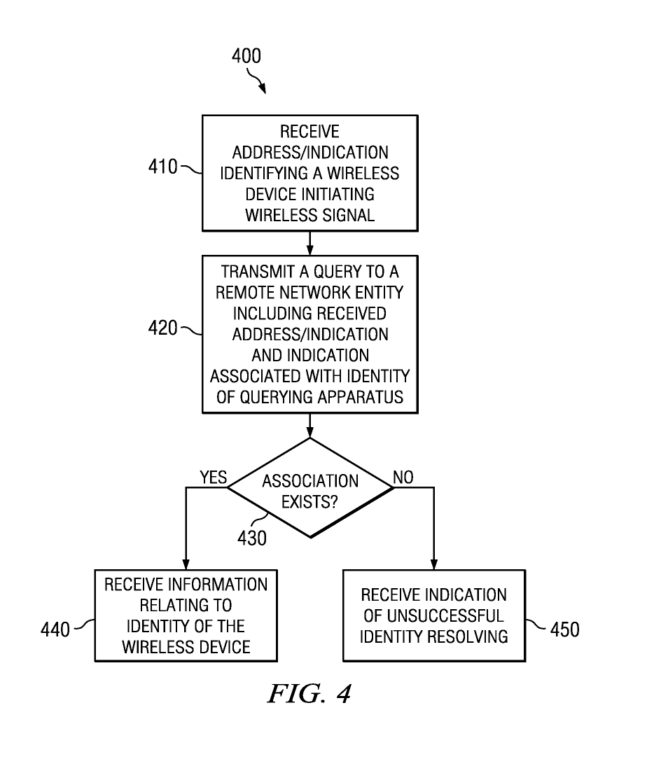

FIG. 4 illustrates an example method 400 for acquiring identity of an apparatus, such as wireless communication device 120 of FIG. 1 according to an example embodiment of the present invention. The example method starts with block 410 where an apparatus, such as the wireless communication device 200 of FIG. 1, is for example searching proximate wireless devices in order to initiate a communication connection with another device, such as wireless communication device 120. Apparatus 200 receives first an address and/or an indication identifying the wireless communication device 120 that may have been transmitted by the wireless communication device 120. Apparatus 200 may optionally check, according to one embodiment of the present invention, whether the received address and/or indication identifying the wireless communication device 120 is previously known, or not. If the received address and/or indication identifying the wireless communication device 120 is known and a secure association is determined to be existing between the apparatus 200 and the wireless communication device 120 using information stored within apparatus 200, a wireless communication connection may be established with the wireless communication device 120 using information associated with the secure association. If the received address and/or indication identifying the wireless communication device 120 is not known, or no secure association exists between the apparatus 200 and the wireless communication device 120, the method continues with block 420 where apparatus 200 processes the received address and/or indication and creates a query for transmitting to a remote network entity, such as server 300 of FIG. 1. Apparatus 200 then transmits the query to server 300 through network 160 according to an example embodiment illustrated on FIG. 1. The query includes according to an example embodiment of the present invention at least an indication associated with the identity of apparatus 200 and the received address and/or an indication identifying the wireless communication device 120.

When an apparatus, such as wireless communication device 120 of FIG. 1 use dynamically changing pseudo-random addresses for advertising its presence in order to hide its identity to listening devices not securely associated with the wireless communication device 120, any listening device not in possession of the necessary secure association information, cannot be even sure whether there is one or more apparatuses present at times when the pseudo-random address used by the wireless communication device 120 changes. This makes tracking of the apparatus, such as the wireless communication device 120 of FIG. 1 by a random listening device close to impossible.

Referring back to the example method 400 of FIG. 4, if it is determined in block 430 that an association exists, apparatus 200 receives information relating to identity of the wireless communication device 120 in block 440. This received information may include for example information that can be used to establish a wireless communication connection with the wireless communication device 120, such as an address to which wireless communication device 120 responds when another apparatus tries to attempt a connection with the wireless communication device 120. Alternatively, or in addition, the received information may include information relating to the identity of the user of the wireless communication device 120, such as name and/or contact address, or like. Apparatus 200 may then initiate communication establishment with the wireless communication device 120 using the received information. Alternatively, apparatus 200 may provide at least a portion of the received information to a user of the apparatus via suitable user interface means, such as user interface 270 and user output 290 of example FIG. 2. With the provided information, user of the apparatus 200 may decide on whether to instruct the apparatus 200 to initiate communication connection establishment with the wireless communication device 120 using the received information.

If it is determined in block 430 that no association exists between apparatus 200 and wireless communication device 120, apparatus 200 receives indication that no successful identity resolving could be made in block 450. So, apparatus 200 has no means to connect with wireless communication device 120. Similarly, if any other wireless communication device, such as device 110 or 130 of example FIG. 1 tries to connect with the wireless communication device 120, corresponding flow of operations may be performed.

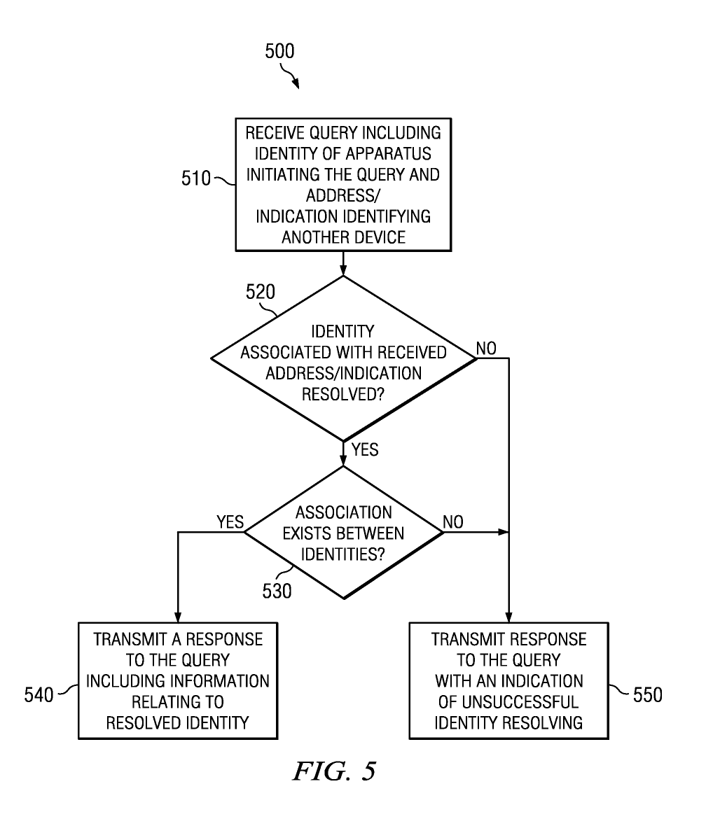

FIG. 5 illustrates an example method 500 for resolving identity of an apparatus according to an example embodiment of the present invention. In block 510, a query is received, wherein the query includes at least an identity of an apparatus initiating the query, such as an identity of apparatus 200 of example FIG. 1, and an address and/or indication identifying another device received by the apparatus 200, such as an address of wireless communication device 120 of example FIG. 1. In block 520, an attempt to resolve identity of an apparatus associated with the address included in the received query is made. The attempt may include selecting a user account from a plurality of maintained user accounts based on the received identity of the apparatus initiating the query.

If the identity of the apparatus is resolved from the address and/or indication identifying the another device included in the query, the method continues with block 530, where determination is made whether an association exists between the resolved identity and the identity of the apparatus initiating the query. The determination may comprise checking whether any of a plurality of data items included in the selected user account comprises information that enables resolving of identity of an apparatus and/or a user of the apparatus from the and/or indication included in the query. If it is determined in block 530 that an association association exists between the resolved identity and the identity of the apparatus initiating the query, the method continues with block 540 where a response is transmitted including information relating to resolved identity. Transmitted information may include for example information that may be used to establish a wireless communication connection with a device, which identity was resolved. Alternatively, or in addition, the transmitted information may include information relating to the identity of the user of the device, which identity was resolved, such as name and/or contact address, or like.

If no identity can be resolved based on the received address and/or indication identifying the other device included in the received query in block 520, the method continues with block 550 where a response is transmitted with an indication of unsuccessfull identity resolving. Similarly, if no association exists between the resolved identity and the identity of the apparatus initiating the query in block 530, the method continues with block 550 where a response is transmitted with an indication of unsuccessfull identity resolving

The phrase “address” used throughout this specification is intended to be considered as as expression that may identify an apparatus and/or a user of the apparatus. So, an “address” in terms of this specification can be considered as whatever that makes an entity definable and recognizable and distinguishes it from other entities. So according to one embodiment of the present invention, an address may comprise a device address, device identifier or some sort of a key that distinguishes the device from other devices. Similarly, according to one embodiment of the present invention, an address may comprise a user identification or some sort of a key that distinguishes the user from other users.

Without in any way limiting the scope, interpretation, or application of the claims appearing below, a technical effect of one or more of the example embodiments disclosed herein may be acquiring identity of a wireless communication device and/or user associated with the wireless communication device based on a received address by requesting the information from a remote entity. Another technical effect may be resolving identity of an apparatus, and providing it to a requesting apparatus.

Various operations and/or the like described herein may be executed by and/or with the help of computers. Further, for example, devices described herein may be and/or may incorporate computers. The phrases “computer”, “general purpose computer”, and the like, as used herein, refer but are not limited to a media device, a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, and/or the like.

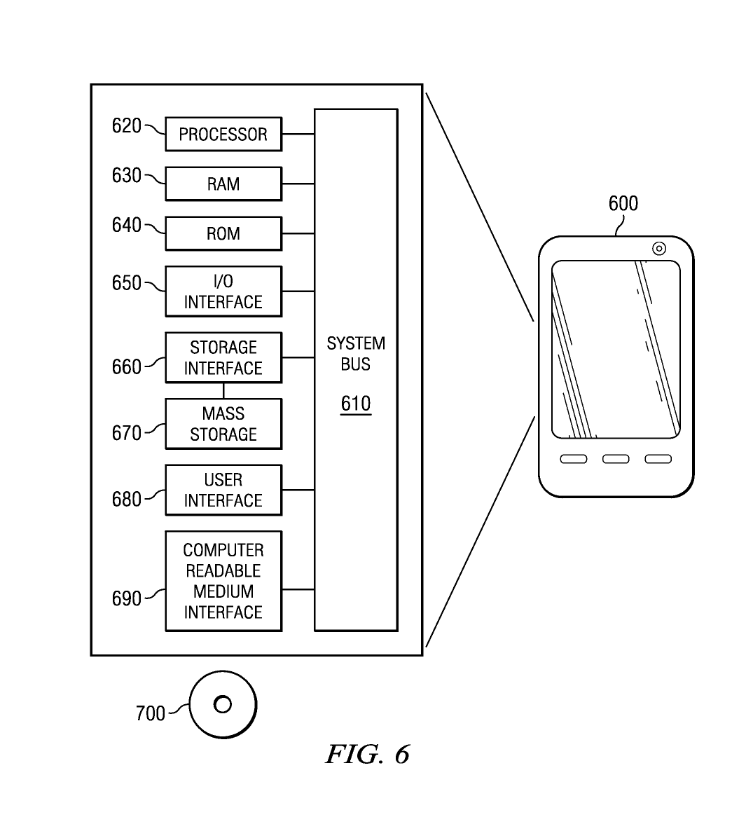

Embodiments of the present invention may be implemented in software, hardware, application logic or a combination of software, hardware and application logic. The software, application logic and/or hardware may reside on a memory of any of the apparatuses 200 and 300 of FIG. 1. In an example embodiment, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that may contain or store the instructions for use by or in connection with an instruction execution system, apparatus, or device, such as a computer.

The phrases “general purpose computer”, “computer”, and the like may also refer to one or more processors operatively connected to one or more memory or storage units, wherein the memory or storage may contain data, algorithms, and/or program code, and the processor or processors may execute the program code and/or manipulate the program code, data, and/or algorithms. Accordingly, example computer 600 as shown in FIG. 6 that may be considered as one embodiment of the apparatuses 200 and 300 illustrated on FIG. 1 may include various hardware modules for causing the computer to implement one or more embodiments of the present invention. According to one example, the computer 600 include a system bus 610 which may operatively connect processor 620, random access memory 630, read-only memory 640 that may store for example a computer code for the computer 600 to perform the example methods illustrated on FIGS. 4 and 5. The system bus 610 may further operatively connect input output (I/O) interface 650, storage interface 660, user interface 680 and computer readable medium interface 690. Storage interface 660 may comprise or be connected to mass storage 670.

Mass storage 670 may be a hard drive, optical drive, or the like. Processor 620 may comprise a microcontroller unit (MCU), a digital signal processor (DSP), or any other kind of processor. Computer 600 as shown in this example also comprises a touch screen and keys operating in connection with the user interface 680. In various example embodiments, a mouse, and/or a keypad may alternately or additionally be employed. Computer 600 may additionally include the computer readable medium interface 680, which may be embodied by a card reader, a DVD drive, a floppy disk drive, and/or the like. Thus, media containing program code, for example for performing method 500 of FIG. 5, may be inserted for the purpose of loading the code onto the computer.

Computer 600 may run one or more software modules designed to perform one or more of the above-described operations. Corresponding program code may be stored on a physical media 700 such as, for example, DVD, CD-ROM, and/or floppy disk. It is noted that any described division of operations among particular software modules is for purposes of illustration, and that alternate divisions of operation may be employed. Accordingly, any operations discussed as being performed by a software module may instead be performed by a plurality of software modules. Similarly, any operations discussed as being performed by a plurality of modules may instead be performed by a single module. It is noted that operations disclosed as being performed by a particular computer may instead be performed by a plurality of computers.

According to one embodiment, a computer program product is provided, the computer program product comprising computer executable program code recorded on a computer readable storage medium, the computer executable program code comprising: A code for causing receipt of a query from an apparatus, the query including at least one of an address or an indication identifying another device received by the apparatus and an indication associated with identity of the apparatus; a code for resolving identity associated with the received address or indication identifying the another device included in the query and determining whether an association exists between the resolved identity and the identity of the apparatus initiating the query, and a code for causing transmission of a response to the query including information relating to resolved identity if the association exists between the resolved identity and the identity of the apparatus initiating the query.

According to one embodiment, a computer program product is provided, the computer program product comprising computer executable program code recorded on a computer readable storage medium, the computer executable program code comprising: A code for causing an associated apparatus to receive a wireless signal comprising at least one of an address or an indication identifying a wireless communication device initiating the wireless signal, a code for causing the associated apparatus to transmit a query to a remote network entity, the query including at least the received address or indication identifying the wireless communication device and an indication associated with identity of the apparatus; and a code for causing the associated apparatus to receiving a response to the query including information relating to identity of the wireless communication device if an association exists between the apparatus and the wireless communication device.

According to one embodiment, an apparatus is provided, the apparatus comprising: A short-range communications module configured to receive a wireless signal comprising at least one of an address or an indication identifying a wireless communication device initiating the wireless signal; a long-range communications module configured to transmit a query to a remote network entity, the query including at least the received address or indication identifying the wireless communication device and an indication associated with identity of the apparatus; and to receive a response to the query including information relating to identity of the wireless communication device if an association exists between the apparatus and the wireless communication device.

According to one embodiment, an apparatus is provided, the apparatus comprising: A communications interface configured to receive a query, the query comprising at least one of an address or indication identifying another device received by a wireless communication device and an indication associated with identity of the wireless communication device initiating the query; a processor configured to resolve identity associated with the address or indication identifying another device included in the query and to determine whether an association exists between the resolved identity and the identity of the wireless communication device initiating the query; wherein the communications interface is further configured to transmit a response to the query including information relating to resolved identity if the association exists between the resolved identity and the identity of the wireless communication device initiating the query.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
receiving, at an apparatus, a wireless signal comprising an indication identifying a wireless communication device initiating the wireless signal;
transmitting a query to a remote network entity, the query including the received indication and an indication associated with identity of the apparatus; and
receiving a response to the query including information relating to identity of the wireless communication device if an association exists between the apparatus and the wireless communication device.

2. A method according to claim 1, wherein the received signal comprises an advertising message including a device address of the wireless communication device.

3. (canceled)

4. A method according to claim 2, wherein the device address comprises a dynamically changing pseudo-random address for hiding identity of the wireless communication device.

5. (canceled)

6. A method according to claim 1, further comprising initiating connection establishment with the wireless communication device using the information received relating to identity of the wireless communication device.

7. (canceled)

8. (canceled)

9. (canceled)

10. (canceled)

11. (canceled)

12. (canceled)

13. (canceled)

14. (canceled)

15. (canceled)

16. (canceled)

17. An apparatus, comprising:
at least one processor; and
at least one memory including executable instructions, the at least one memory and the executable instructions being configured to, in cooperation with the at least one processor, cause the apparatus to perform at least the following:
receive a wireless signal comprising an indication identifying a wireless communication device initiating the wireless signal;
transmit a query to a remote network entity, the query including the received indication and an indication associated with identity of the apparatus; and
receive a response to the query including information relating to identity of the wireless communication device if an association exists between the apparatus and the wireless communication device.

18. An apparatus according to claim 17, wherein the received signal comprises an advertising message including a device address of the wireless communication device.

19. (canceled)

20. An apparatus according to claim 17, wherein the device address comprises a dynamically changing pseudo-random address for hiding identity of the wireless communication device.

21. (canceled)

22. An apparatus according to claim 17, wherein the at least one memory and the executable instructions being configured to, in cooperation with the at least one processor, cause the apparatus to further perform at least the following:
initiate connection establishment with the wireless communication device using the information received relating to identity of the wireless communication device.

23. An apparatus according to claim 17, wherein the received wireless signal comprises a Bluetooth® Low Energy advertising message.

24. A method, comprising:
receiving a query from an apparatus, the query including an indication associated with identity of the apparatus and an indication identifying another device;
resolving identity associated with the indication identifying the another device included in the query and determining whether an association exists between the resolved identity and the identity of the apparatus initiating the query; and
transmitting a response to the query including information relating to resolved identity if the association exists between the resolved identity and the identity of the apparatus initiating the query.

25. (canceled)

26. A method according to claim 24, wherein the existence of the association between the resolved identity and the identity of the apparatus initiating the query is determined based on checking whether a user account associated with the identity of the apparatus initiating the query contains indication of the association matching with the resolved identity.

27. A method according to claim 24, further comprising maintaining user accounts including information relating to at least one of identities of one or more apparatuses of associated users, information relating to the identities of the associated users and indications of associations between various users.

28. A method according to claim 24, further comprising transmitting a response to the query with an indication of unsuccessful identity resolving when no association exists between the resolved identity and the identity of the apparatus initiating the query.

29. A method according to claim 24, wherein the indication identifying the another device comprises a device address dynamically changing pseudo-random address for hiding identity of the another device.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. An apparatus, comprising:
at least one processor; and
at least one memory including executable instructions, the at least one memory and the executable instructions being configured to, in cooperation with the at least one processor, cause the apparatus to perform at least the following:
receive a query from an apparatus, the query including an indication associated with identity of the apparatus and an indication identifying another device;
resolve identity associated with the indication identifying the another device included in the query and determine whether an association exists between the resolved identity and the identity of the apparatus initiating the query; and
transmit a response to the query including information relating to resolved identity if the association exists between the resolved identity and the identity of the apparatus initiating the query.

43. (canceled)

44. An apparatus according to claim 42, wherein the existence of the association between the resolved identity and the identity of the apparatus initiating the query is determined based on checking whether a user account associated with the identity of the apparatus initiating the query contains indication of an association matching with the resolved identity.

45. An apparatus according to claim 42, wherein the at least one memory and the executable instructions being configured to, in cooperation with the at least one processor, cause the apparatus to further perform at least the following:
maintain user accounts including information relating to at least one of identities of one or more apparatuses of associated users, information relating to the identities of the associated users and indications of associations between various users.

46. An apparatus according to claim 42, wherein the at least one memory and the executable instructions being configured to, in cooperation with the at least one processor, cause the apparatus to further perform at least the following:
transmit a response to the query with an indication of unsuccessful identity resolving when no association exists between the resolved identity and the identity of the apparatus initiating the query.

47. An apparatus according to claim 42, wherein the indication identifying the another device comprises a device address dynamically changing pseudo-random address for hiding identity of the another device.

48. (canceled)

49. (canceled)

50. A computer program product comprising computer executable program code recorded on a non-transitory storage medium, the computer executable program code comprising:
a code for causing receipt of a query from an apparatus, the query including an indication associated with identity of the apparatus and an indication identifying another device;
a code for resolving identity associated with indication identifying the another device included in the query and determining whether an association exists between the resolved identity and the identity of the apparatus initiating the query; and
a code for causing transmission of a response to the query including information relating to resolved identity if the association exists between the resolved identity and the identity of the apparatus initiating the query.

51. (canceled)

52. (canceled)

53. A computer program product comprising computer executable program code recorded on a non-transitory storage medium, the computer executable program code comprising:
a code for causing an associated apparatus to receive a wireless signal comprising an indication identifying a wireless communication device initiating the wireless signal;
a code for causing the associated apparatus to transmit a query to a remote network entity, the query including the received indication and an indication associated with identity of the apparatus; and
a code for causing the associated apparatus to receiving a response to the query including information relating to identity of the wireless communication device if an association exists between the apparatus and the wireless communication device.

54. (canceled)
